(19) United States
(12) Patent Application Publication
(10) Pub. No.: US 2023/0133683 A1
(43) Pub. Date: May 4, 2023

(54) FEATURE INTERACTION VIA EDGE SEARCH

(71) Applicant: Alibaba Group Holding Limited, Grand Cayman (KY)

(72) Inventors: Yuexiang XIE, Hangzhou (CN); Zhen Wang, Hangzhou (CN); Bolin Ding, Redmond, WA (US); Yaliang Li, Bellevue, WA (US); Jun Huang, Hangzhou (CN); Weidan Kong, Redmond, WA (US); Jingren Zhou, Hangzhou (CN); Wei Lin, Hangzhou (CN)

(21) Appl. No.: 17/421,358

(22) PCT Filed: Jul. 14, 2020
(86) PCT No.: PCT/CN2020/101902

§ 371 Date: Jul. 7, 2021

(51) Int. Cl. G06N 3/092; G06N 3/047

(52) U.S. Cl. CPC G06N 3/092; G06N 3/047

(57) ABSTRACT

An interactive feature generation system may receive a plurality of distinct features that are associated with an application, and associate a plurality of nodes in a feature graph of a first order to the plurality of distinct features. The interactive feature generation system may iteratively generate interactive features of a higher order from interactive features of a lower order to form a plurality of feature graphs of different orders. The interactive feature generation system may then propagate respective interactive features of the plurality of feature graphs of the different orders to a neural network to determine a number of interactive features of one or more orders, the determined number of interactive features of the one or more orders being used for training a predictive model to make inferences for the application.

### BACKGROUND

Feature interaction is an important step in feature engineering. A feature interaction occurs when the behavior of one feature is affected by the presence of another feature, and such interaction usually cannot be deduced easily from intended behaviors of the individual features that are involved. By combining features in a certain way, a number of high-order interactive features (i.e., crossing features) can be generated to better represent data and improve learning performance in machine learning. For example, a third-order interactive feature “Gender⊗Age⊗Income” may be used as a strong feature for determining types of advertisements to be recommended to users in advertisement recommendation applications.

Traditionally, interactive feature generation methods rely heavily on experience and knowledge of experts, which are not only time consuming, but also task-specific. Although automatic interactive feature generation methods (which are mainly divided into two categories, namely, search-based methods and deep-learning-based methods) have been developed, these automatic interactive feature generation methods suffer challenges caused by excessively large search spaces (e.g., due to a trial and error approach adopted in the search-based methods) or a lack of interpretability (e.g., due to an implicit nature of feature interactions in the deep-learning-based methods). In other words, these existing automatic methods cannot generate useful and explicit interactive features in a simple and effective training manner.

### SUMMARY

This summary introduces simplified concepts of an interactive feature generation system, which will be further described below in the Detailed Description. This summary is not intended to identify essential features of the claimed subject matter, nor is it intended for use in limiting the scope of the claimed subject matter.

This disclosure describes example implementations of an interactive feature generation system. In implementations, the interactive feature generation system may receive a plurality of distinct features that are associated with an application, and associate a plurality of nodes in a feature graph of a first order to the plurality of distinct features. The interactive feature generation system may iteratively generate interactive features of a higher order from interactive features of a lower order to form a plurality of feature graphs of different orders. In implementations, the interactive feature generation system may then propagate respective interactive features of the plurality of feature graphs of the different orders to a neural network to determine a number of interactive features of one or more orders, the determined number of interactive features of the one or more orders being used for training a predictive model to make inferences for the application.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment in which an example interactive feature generation system may be used.

FIG. 2 illustrates the example interactive feature generation system in more detail.

FIG. 3 illustrates processing stages of an example method of interactive feature generation.

FIG. 4 illustrates an instance of an example production of an adjacency matrix.

FIG. 5 illustrates an example method of interactive feature generation.

### DETAILED DESCRIPTION

### Overview

As noted above, interactive feature generation is an important task in feature engineering. However, existing interactive feature generation methods suffer from challenges due to excessively large search spaces or difficulties in interpretability for developing general feature interaction rules caused by an implicit nature of feature interactions. In other words, these existing methods fail to generate useful and explicit interactive features in a simple and effective training manner.

This disclosure describes an example interactive feature generation system. The interactive feature generation system may find interactive features of various orders (i.e., combinations of various numbers of distinct features), which are useful to improve the performance of a predictive model that is built thereon. In implementations, the interactive feature generation system may adopt a feature graph, which models each feature as a node and characterizes an interaction between two nodes as an edge.

In implementations, the interactive feature generation system may generate K number of feature graphs to represent interactive features of second order to (K+1)th order, with the features graphs having a hierarchical relationship with each other. In implementations, the interactive feature generation system may generate interactive features in a consecutive or iterative manner. For example, the interactive feature generation system may generate high-order interactive features from low-order interactive features and a corresponding feature graph.

In implementations, in order to find useful interactive features for a predictive model from among a large number of potential interactive features, the interactive feature generation system may perform an edge search to generate candidate interactive features through, for example, a Markov Decision Process (MDP). By way of example and not limitation, given interactions of a number of k-order interactive features as a current state, the interactive feature generation system may optimally decide a crossing action to produce (k+1)-order interactive features for high rewards (e.g., the performance of the predictive model trained on selected interactive features). Furthermore, in order to enable effective and efficient optimization of the edge search, in implementations, the interactive feature generation system may perform the edge search under neural network architecture, and edge parameters of the feature graph may be learned in a differentiable manner.

Furthermore, the interactive feature generation system may optimize parameters that are used for controlling a process of the edge search according to predicted results that are obtained as feedback during a training process. In implementations, in order to make the optimization to be differentiable, the interactive feature generation system may further relax hard binarization of edges of a feature graph (which act as probabilities of connections between corresponding nodes of the feature graph), i.e., allowing an edge to take any value within a range of [0, 1].

After the training process, the interactive feature generation system may reconstruct useful interactive features according to the K number of feature graphs. In implementations, the interactive feature generation system may employ these interactive features to train a lightweight or less complicated model (such as a logistic regression model) that may be used by real-time inference systems.

In implementations, functions described herein to be performed by the interactive feature generation system may be performed by multiple separate units or services. Moreover, although in the examples described herein, the interactive feature generation system may be implemented as a combination of software and hardware installed in a single device, in other examples, the interactive feature generation system may be implemented and distributed in multiple devices or as services provided in one or more computing devices over a network and/or in a cloud computing architecture.

The application describes multiple and varied embodiments and implementations. The following section describes an example framework that is suitable for practicing various implementations. Next, the application describes example systems, devices, and processes for implementing an interactive feature generation system.

### Example Environment

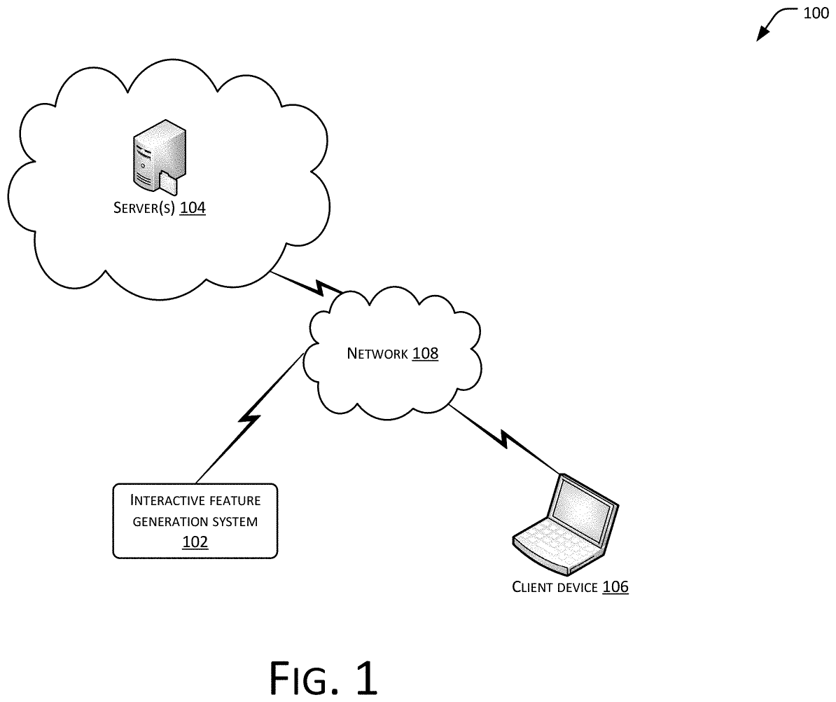

FIG. 1 illustrates an example environment 100 usable to implement an interactive feature generation system. The environment 100 may include an interactive feature generation system 102. In this example, the interactive feature generation 102 is described to exist as an individual entity or device. In some instances, the interactive feature generation system 102 may be included in one or more servers 104, such as one or more computing devices or nodes in a cloud architecture. In other instances, the interactive feature generation system 102 may be included in a client device 106. For instance, some or all of the functions of the interactive feature generation system 102 may be included in or provided by the one or more servers 104, and/or the client device 106, which are connected and communicated via a network 108.

In implementations, the client device 106 may be implemented as any of a variety of computing devices including, but not limited to, a desktop computer, a notebook or portable computer, a handheld device, a netbook, an Internet appliance, a tablet or slate computer, a mobile device (e.g., a mobile phone, a personal digital assistant, a smart phone, etc.), a server computer, etc., or a combination thereof.

The network 108 may be a wireless or a wired network, or a combination thereof. The network 108 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. Wired networks may include an electrical carrier connection (such a communication cable, etc.) and/or an optical carrier or connection (such as an optical fiber connection, etc.). Wireless networks may include, for example, a WiFi network, other radio frequency networks (e.g., Bluetooth®, Zigbee, etc.), etc.

In implementations, the interactive feature generation system 102 may receive a request for generating or selecting interactive features for a particular application (such as an advertisement recommendation application, a product recommendation application, etc.) from a client device (e.g., the client device 106) of a user. In implementations, the interactive feature generation system 102 may further receive additional information from the client device 106. The additional information may include, but is not limited to, information of raw or original features from which interactive or combinatorial features are to be generated, and information of training data that is used for training and generating the interactive or combinatorial features, etc. After receiving the request, the interactive feature generation system 102 may perform an interactive feature generation method as described hereinafter to generate or select a number of interactive features for that particular application. In implementations, the interactive feature generation system 102 may return the number of interactive features to the client device 106 for presentation and/or manipulation by the user of the client device 106. In implementations, the interactive feature generation system 102 may further provide these interactive features to train a lightweight or less complicated model (such as a linear regression model), and return the trained model to the client device 106, so that the client device 106 may perform real-time inferences for the particular application.

Example Interactive Feature Generation system

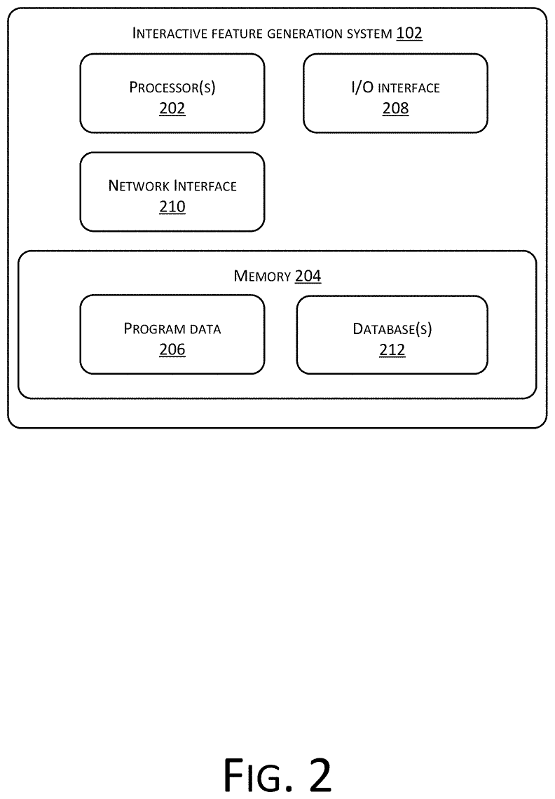

FIG. 2 illustrates the interactive feature generation system 102 in more detail. In implementations, the interactive feature generation system 102 may include, but is not limited to, one or more processors 202, a memory 204, and program data 206. In implementations, the interactive feature generation system 102 may further include an input/output (I/O) interface 208, and/or a network interface 210. In implementations, some of the functions of the interactive feature generation system 102 may be implemented using hardware, for example, an ASIC (i.e., Application-Specific Integrated Circuit), a FPGA (i.e., Field-Programmable Gate Array), and/or other hardware.

In implementations, the processors 202 may be configured to execute instructions that are stored in the memory 204, and/or received from the input/output interface 208, and/or the network interface 210. In implementations, the processors 202 may be implemented as one or more hardware processors including, for example, a microprocessor, an application-specific instruction-set processor, a physics processing unit (PPU), a central processing unit (CPU), a graphics processing unit, a digital signal processor, a tensor processing unit, etc. Additionally or alternatively, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc.

The memory 204 may include computer readable media in a form of volatile memory, such as Random Access Memory (RAM) and/or non-volatile memory, such as read only memory (ROM) or flash RAM. The memory 204 is an example of computer readable media.

The computer readable media may include a volatile or non-volatile type, a removable or non-removable media, which may achieve storage of information using any method or technology. The information may include a computer readable instruction, a data structure, a program module or other data. Examples of computer readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include any transitory media, such as modulated data signals and carrier waves.

Although in this example, only hardware components are described in the interactive feature generation system 102, in other instances, the interactive feature generation system 102 may further include other hardware components and/or other software components such as program units to execute instructions stored in the memory 204 for performing various operations. For example, the interactive feature generation system 102 may further include one or more databases 212 that are configured to store training data, parameters of predictive models, information associated with feature graphs, (initial, intermediate, or final) information associated with interactive features, etc.

### Example Interactive Feature Generation Algorithm

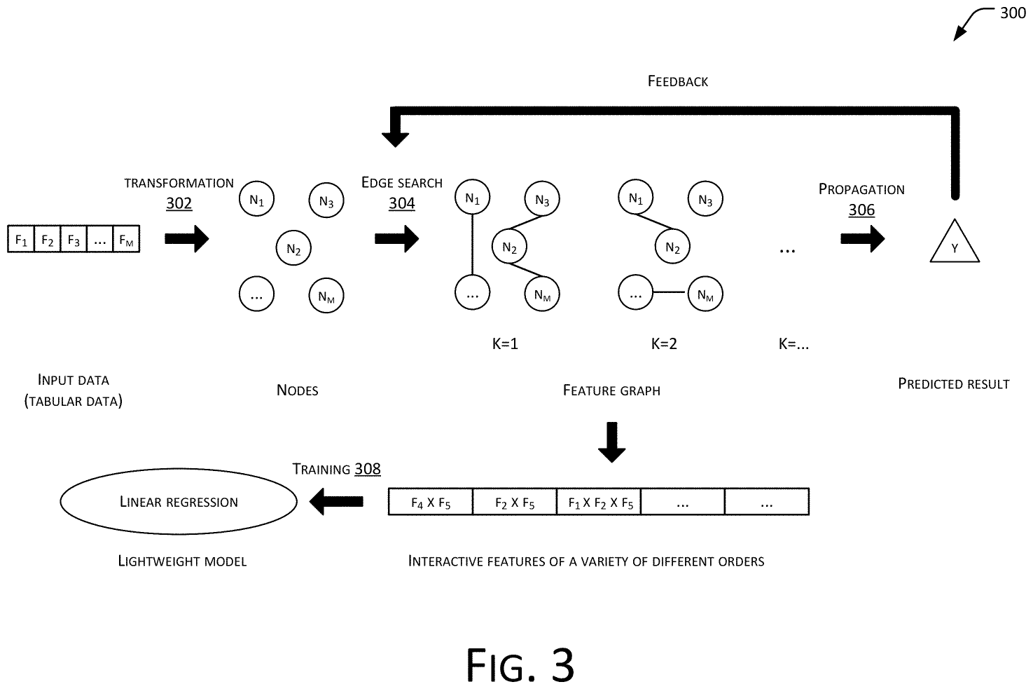

FIG. 3 shows a schematic diagram depicting processing stages of an example method of interactive feature generation. In implementations, the example method 300 may include at least four stages, namely, a transformation stage 302, an edge search stage 304, a propagation stage 306, and a training stage 308.

In implementations, at the transformation stage 302, the interactive feature generation system 102 may construct a Feature Graph [symbol] to represent each row of input data associated with a particular application or application model. In implementations, the input data may be stored or presented in a tabular form, and may include multiple fields, with each field storing a distinct feature. In implementations, each node nᵢ of the Feature Graph [symbol] may indicate a distinct feature of the input data, and an edge e_{i,j} between two nodes (e.g., nᵢ and nⱼ) of the feature graph may represent an interaction between these two nodes.

In implementations, the interactive feature generation system 102 may use one-hot encoding to represent features of the input data, and map the features of the input data to distributed feature embedding vectors. In implementations, these feature embedding vectors may then be defined as nodes of the Feature Graph [symbol] . For example, given the input data F=[f₁, f₂, . . . , fₘ], where m is the number of features, the nodes of the Feature Graph [symbol] may be defined or labeled as

N=[n₁, n₂, . . . , nₘ] (1)

where each element nᵢ∈ [symbol] ^{h}, and h is the dimension of the feature embedding vectors.

In implementations, the nodes (i.e., the features) of the Feature Graph [symbol] may interact with each other through edges, and an adjacency matrix A^{k}∈ [symbol] ^{m×m} may be used to represent connections of the (k+1)-order interactive features in the Feature Graph [symbol] . By way of example and not limitation, an adjacency matrix may be a binary matrix, such that an element A_{i,j}^{k} thereof is 1 if an edge from node nᵢ to node nⱼ exists, and 0 otherwise. In implementations, the interactive feature generation system 102 may construct an adjacency tensor A∈ [symbol] ^{K×m×m}, in which a k-th slice A^{k} of the adjacency tensor A may be referred to as an adjacency matrix, to record connections between interactive features of different orders. These K adjacency matrices or the adjacency tensor may be considered as the architecture of the Feature Graph [symbol] , and may be determined via an edge search at the edge search stage 304.

For example, a k-order interactive feature f^{k} may be defined as a crossing product of selected k distinct features as follows:

f^{k}=f_{c}_{₁}⊗f_{c}_{₂}⊗ . . . ⊗f_{c}_{ₖ} (2)

where ⊗ represents a crossing product operation (e.g., a Cartesian product) and each selected feature f_{c}_{ᵢ}∈F.

At the edge search stage 304, the interactive feature generation system 102 may employ an edge state H=[H¹, H², . . . , H^{k}]∈ [symbol] ^{K×m×m} to represent probabilities of interactions between nodes in the Feature Graph [symbol] , with K being the highest order of feature crossing or feature interaction. For example, for a k^{th} matrix H^{k}∈ [symbol] ^{m×m}, an element H_{i,j}^{k} thereof is a probability of interaction between a corresponding pair of nodes (i.e., nᵢ and nⱼ), while k-order interactive features are generated. In implementations, the adjacency matrices or the adjacency tensor A may be regarded as Bernoulli random variables parameterized by the edge state H.

In implementations, the interactive feature generation system 102 may determine the adjacency tensor A via an edge search. By way of example and not limitation, the interactive feature generation system 102 may employ a Markov Decision Process (MDP) to model a process of determining adjacency matrices A via an edge search. For example, the interactive feature generation system 102 may divide a generation of a k-order interactive feature f^{k} into k consecutive decision steps. In each decision step, the interactive feature generation system 102 may select some of the first-order features (i.e., original features) that are received from the input data to cross with high-order interactive features to generate higher-order interactive features.

By way of example and not limitation, given a (k−1)-order interactive feature f^{k-1} as a current state, the interactive feature generation system 102 may make a strategic decision to select a certain first-order feature, and cross the selected first-order feature with the (k−1)-order interactive feature f^{k-1} to generate a k-order interactive feature f^{k}. In implementations, the edge state H, which represents a probability of an interaction between two nodes, may be used to guide a crossing decision of the interactive feature generation system 102. For example, a high probability of an interaction between two nodes (i.e., two features) means that a high probability of being selected for crossing between these two nodes (i.e., these two features).

In implementations, each matrix H^{k}∈H represents interactions of first-order features (i.e., original features), rather than those of k-order features, and is set up in such a way that the edge search can be viewed as a MDP, for example. In implementations, a process of edge search may be represented in a recursive form as follows:

A^{k}=φ((D^{k-1})⁻¹A^{k-1}H^{k}) (3)

A⁰=I (4)

where φ(x) is a binarization function, I is an identity matrix, D is a normalization matrix which is defined as:

$$φ ( x ) = \{ \begin{matrix}1 & x > α \\ 0 & x \leq α\end{matrix} \qquad ( 5 )$$

$${D}_{i , :} = {\sum }_{j} {A}_{i , j} \qquad ( 6 )$$

where α is a threshold value that is adjustable.

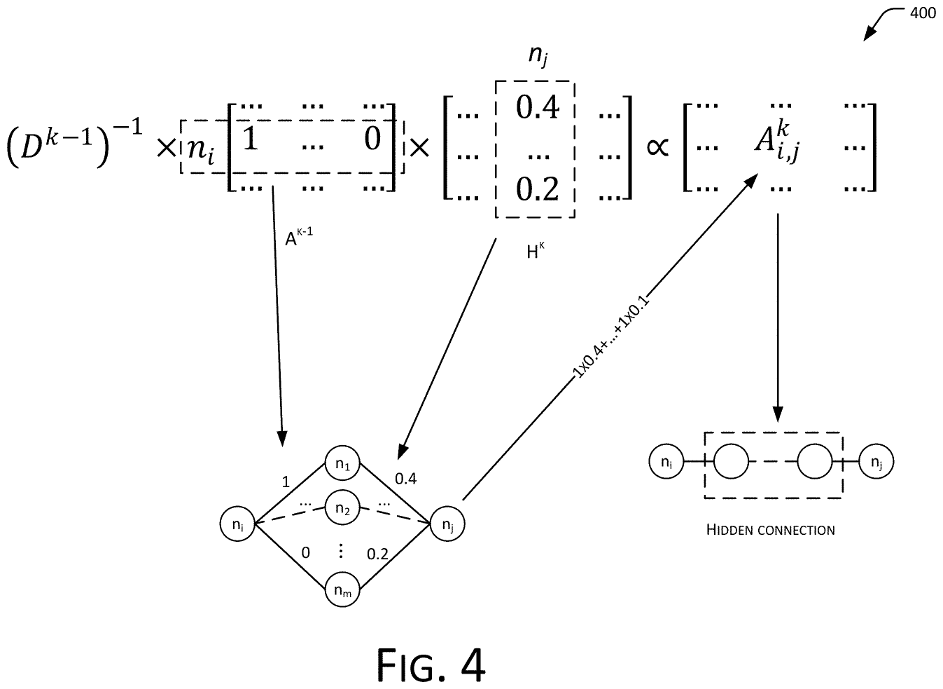

FIG. 4 shows a schematic diagram depicting an instance of an example production 400 of an adjacency matrix. In implementations, a matrix multiplication of A^{k-1}H^{k} may be considered as information compression of a two-hop connection into an adjacency matrix as shown in FIG. 4. A calculated result x may denote a probability of a multi-hop connection that starts with nᵢ and ends with nⱼ, which may correspond to an interactive feature f^{k}=fᵢ⊗ . . . ⊗fⱼ. Therefore, the obtained adjacency matrix A^{k} may aggregate interactions of (k−1)-order interactive features and corresponding cross probabilities, and may be used to represent interactions of k-order interactive features. In implementations, each (k+1)-order interactive feature, e.g., fᵢ⊗ . . . ⊗fⱼ, may be regarded as a k-hop path jumping from node nᵢ to nⱼ, and A^{k} may be treated as a binary sample drawn from a k-hop transition matrix (or a transition matrix of k-hop) where A_{i,j}^{k} indicates a k-hop visibility (or say accessibility) from nᵢ to nⱼ. In implementations, the transition matrix of k-hop may be calculated by multiplying a transition matrix of (k−1)-hop with a corresponding adjacency matrix. Since topological structures at different layers tend to vary from each other, H^{k} may be designed as a layer-wise transition matrix.

In implementations, at the propagation stage 306, given the Feature Graph [symbol] with node vectors N and corresponding adjacency matrices or adjacency tensor A, a propagation process of vector-wise feature crossing based on a graph neural network (GNN) may be defined. For example, in a k-order feature crossing, each node may aggregate information from respective one-hop neighbors to form an aggregated node vector, which is a sum of initial node vectors (i.e., feature embedding vectors) of the neighbors:

pᵢ^{k}=MEAN_{j|A}_{ᵢⱼ}_{^{k}}₌₁ (7)

nᵢ^{k}=pᵢ^{k}⊙nᵢ^{k-1} (8)

where Wⱼ is a transformer matrix for node vector nⱼ.

After K times of aggregation, the interactive feature generation system 102 may obtain node vectors as follows:

N^{K}=[n₁^{K}, n₂^{K}, . . . , nₘ^{K}] (9)

In implementations, the node vectors may include k-order interactive or crossing features. Since the node vectors nᵢ^{K} have interacted with respective K-order neighbors, K-order interactive or crossing features may be modeled.

In implementations, at the training stage 308, the interactive feature generation system 102 may train a lightweight predictive model, such as a non-linear projection, and apply the lightweight predictive model on the node vectors as follows:

ŷ^{k}=σ(Wₚ^{T}[n₁^{k}:n₂^{k}: . . . : nₘ^{k}]) (10)

where Wₚ is a projection matrix which may linearly combine concatenated features, and σ(x)=1/(1+e^{-x}) may transform values to probabilities.

In implementations, the interactive feature generation system 102 may further perform optimization of the generation of interactive features. In implementations, as described in the foregoing description, the edge state H may guide the interactive feature generation system 102 to make a decision for feature crossing, which may be regarded as a policy, and may be optimized to achieve a high reward. In implementations, the interactive feature generation system 102 may construct or employ a reward function to guide the interactive feature generation system 102 to take an action that produces a high or maximum reward. In implementations, the reward function may include, but is not limited to, a negation of a log loss as shown below:

$${ℒ}^{k} = - \frac{1}{D} \sum ( {y}_{i} log ( {\hat{y}}_{i}^{k} ) + ( 1 - {y}_{i} ) log ( 1 - {\hat{y}}_{i}^{k} ) ) \qquad ( 11 )$$

$${R}^{k} = - {ℒ}^{k} \qquad ( 12 )$$

where yᵢ and ŷᵢ^{k} are ground truth and estimated probabilities respectively, and D is the total number of training samples.

In implementations, in a k^{th} order, a value function Q^{k} may include an immediate reward and a long term reward:

Q^{k}=R^{k}+Σᵢ₌₁^{K-k}γⁱR^{k+i} (13)

where K is the highest order, and γ∈[0, 1] is a discounted factor. An intuition behind this value function is to request an agent (e.g., the interactive feature generation system 102) to consider both the usefulness of generating low-order interactive or crossing features (i.e., the immediate reward) and related high-order interactive features that may generate in subsequent or higher orders (i.e., the long term reward). Since under the propagation stage 306 as described in the foregoing description, high-order interactive features may rely on low-order interactive features, an objective function that may be used by the interactive feature generation system 102 may include, but is not limited to:

$${ℒ}^{′} = \frac{1}{k} {\sum }_{i = 1}^{K} - {Q}^{i} \qquad ( 14 )$$

In implementations, since an edge state matrix may be binarized by the interactive feature generation system 102 to obtain an adjacency matrix, for example, using Equation (5) as described above, the edge state matrix may not be directly optimized by minimizing the loss [symbol] ′ as defined in Equation (14) using a back propagation (BP) approach.

In implementations, to make the optimization more effective and efficient, the interactive feature generation system 102 may perform the optimization of the edge state H as a neural architecture search (NAS). By way of example and not limitation, the interactive feature generation system 102 may relax the hard binarization of the adjacency matrix as the probability of interaction of nodes. The adjacency matrix of order of k depends on edge state matrix and the binarization of the adjacency matrix in previous order (i.e., the current state), which can be formally given as:

A^{k}=(D^{k-1})⁻¹φ(A^{k-1})H^{k} (15)

In implementations, a gap between training using soft probability and testing with hard binary adjacency matrix may exist due to the use of differentiable optimization technologies. In implementations, the interactive feature generation system 102 may employ a continuous distribution that approximates samples from a categorical distribution and works with back propagation. For example, the interactive feature generation system 102 may apply a variant of gumbel softmax on each element of A^{k} to reduce the performance loss:

$${a}^{k} = σ ( \frac{log [ {a}^{k} / ( 1 - {a}^{k} ) ]}{τ} ) \qquad ( 16 )$$

where σ(x)=1/1+e^{-x}, α^{k} is an element of A^{k}, and τ is a temperature parameter. As τ approaches 0, σ becomes binary (i.e., close to 0 or 1).

In implementations, after enabling relaxation from hard binarization as described in the foregoing description, a task of edge search may include optimizing continuous parameters via a back propagation algorithm. If edge state parameters are denoted as Wₑ and model parameters are denoted as Wₒ, we split the dataset D may be split into a training set Dₜᵣₐᵢₙ and a validation set Dᵥₐₗ. an example training algorithm may include the following:

Training Algorithm

Input: Feature Graph [symbol] = ( [symbol] , [symbol] ), highest order K, learning rate α₁, α₂, and #epochs
T
1: for t=1,2,...,T do:
2: Calculate A according to Equation (15);
3: Perform propagation for K crossing orders according to Equations (7) and (8);
4: Update model parameters Wₒ by descending α₁∇_{w}_{ₒ}L′(Dₜᵣₐᵢₙ\Wₒ, Wₑ);
5: Update edge parameters Wₑ by descending α₂∇_{w}_{ₑ}L′(Dᵥₐₗ\Wₒ, Wₑ);
6: end for

In implementations, at the end of the edge search stage 304, the interactive feature generation system 102 may directly obtain binary adjacency matrices by applying a binarization function with a tunable threshold value on the adjacency matrices that are obtained in the edge search stage 304, and reconstruct useful interactive features of various orders based on the binary adjacency matrices. In implementations, the interactive feature generation system 102 may further train a lightweight or less complicated model (such as a linear regression model, etc.) using these interactive features of various orders to enable performing inferences in real time. Moreover, in implementations, the interactive feature generation system 102 may specify layer-wise thresholds for binarizing the learned A, and inductively derive the useful k-order (1<k<K) interactive features {f_{c}_{₁}⊗ . . . ⊗f_{c}_{₁}|∃_{c}_{₁}_{, . . . , c}_{ₖ},s.t.,A_{c}_{ⱼ}_{,c}_{ⱼ₊₁}^{j}=1, j=0, . . . , k−1}.

### Example Methods

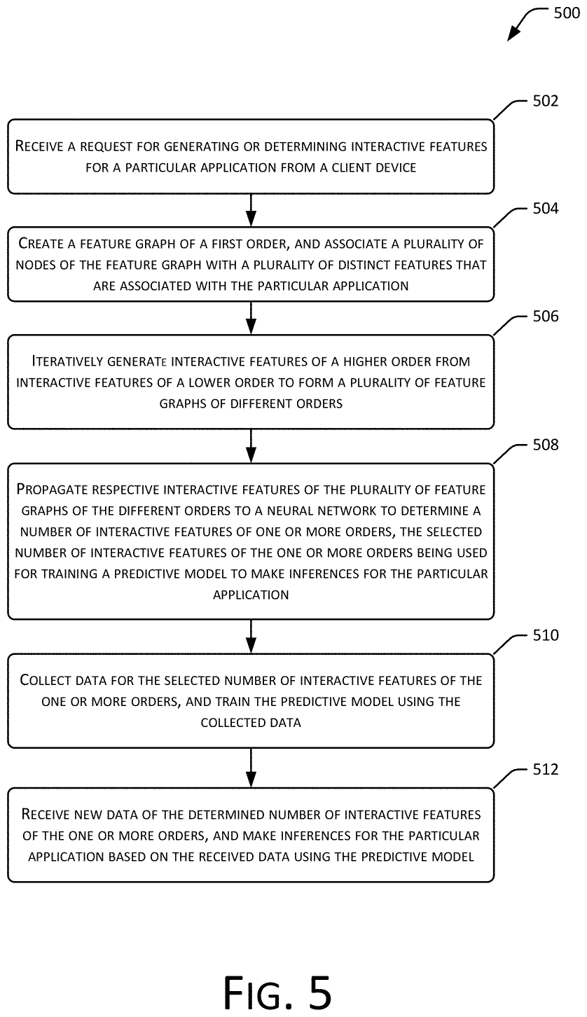

FIG. 5 shows a schematic diagram depicting an example method of interactive feature generation. The method of FIG. 5 may, but need not, be implemented in the environment of FIG. 1 and using the system of FIG. 2 with the processing stages of FIG. 3 and the instance of FIG. 4. For ease of explanation, a method 400 is described with reference to FIGS. 1-4. However, the method 500 may alternatively be implemented in other environments and/or using other systems.

The method 500 is described in the general context of computer-executable instructions. Generally, computer-executable instructions can include routines, programs, objects, components, data structures, procedures, modules, functions, and the like that perform particular functions or implement particular abstract data types. Furthermore, each of the example methods are illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 500, at block 502, the interactive feature generation system 102 may receive a request for generating or determining interactive features for a particular application from a client device.

In implementations, the interactive feature generation system 102 may receive a request for generating or determining interactive features for a particular application (such as an advertisement recommendation application, a product recommendation application, etc.) from a client device (e.g., the client device 106) of a user. In implementations, the interactive feature generation system 102 may further receive additional data from the client device 106. In implementations, the additional data may be included in the request, or may be sent by the client device as information separate from the request. In implementations, the additional data may be data stored in a storage device accessible to the interactive feature generation system 102, and the interactive feature generation system 102 may retrieve the additional data from the storage device upon receiving address information of the additional data included in the request or the separate information from the client device. In implementations, the additional data may include, but is not limited to, information of raw or original features from which interactive or combinatorial features are to be generated, and information of training data that is used for training and generating the interactive or combinatorial features, etc.

In implementations, the raw or original features from which interactive or combinatorial features may be stored or inputted in a tabular form, such as tabular data.

At block 504, the interactive feature generation system 102 may create a feature graph of a first order, and associate a plurality of nodes of the feature graph with a plurality of distinct features that are associated with the particular application.

In implementations, upon receiving the request from the client device, the interactive feature generation system 102 may further obtain data of a plurality of distinct features that are associated with the particular application and that are to be selectively or strategically combined as interactive features of various orders. In implementations, the interactive feature generation system 102 may transform or convert the data of the plurality of distinct features into a feature vector representation (such as a vector representation, for example) to obtain feature embedding vectors.

In implementations, the interactive feature generation system 102 may convert the plurality of distinct features into a feature representation using a one-hot encoding, and map the feature representation into feature embedding vectors.

By way of example and not limitation, the interactive feature generation system 102 may transform or convert the data of the plurality of distinct features using one-hot encoding. The one-hot encoding is a representation of categorical variables (which include label values rather than numeric values) as binary vectors, and includes mapping label values to integer values. Each integer value is represented as a binary vector which element is zero except an index of an integer which is marked as one. For example, if a “color” variable includes three categories, namely, red, green, and blue, one-hot encoding may represent these three label values (i.e., red, green, and blue) as three different binary vectors, namely, [1, 0, 0], [0, 1, 0], and [0, 0, 1] respectively. In implementations, after transforming the data of the plurality of distinct features, the interactive feature generation system 102 may obtain a plurality of feature embedding vectors.

In implementations, the interactive feature generation system 102 may further create a feature graph (e.g., the Feature Graph [symbol] as described in the foregoing description), and associate a plurality of nodes in the feature graph with the plurality of feature embedding vectors. In implementations, the interactive feature generation system 102 may model each distinct features of the plurality of distinct features as a respective node of the plurality of nodes in the feature graph, and an interaction between two distinct features of the plurality of distinct features as an edge between corresponding nodes of the plurality of nodes in the feature graph. For example, given the data of the plurality of distinct features as F=[f₁, f₂, . . . , fₘ], where m is the number of features, the nodes of the feature graph may be defined or labeled as N=[n₁, n₂, . . . , nₘ], where each element nᵢ∈ [symbol] ^{h}, and h is the dimension of the feature embedding vectors as described in the foregoing description.

In implementations, the nodes (i.e., the features) of the Feature Graph [symbol] may interact with each other through edges, and an adjacency matrix A∈ [symbol] ^{m×m} may be used to represent connections in the Feature Graph [symbol] . By way of example and not limitation, an adjacency matrix may be a binary matrix, such that an element A_{i,j} thereof is 1 if an edge from node nᵢ to node nⱼ exists, and 0 otherwise. In implementations, the interactive feature generation system 102 may construct K adjacency matrices to record connections interactive features of different orders.

At block 506, the interactive feature generation system 102 may iteratively generate interactive features of a higher order from interactive features of a lower order to form a plurality of feature graphs of different orders.

In implementations, the Feature Graph [symbol] as described in the foregoing description may include a plurality of feature graphs of different orders. For example, a feature graph of a first order (or first-order feature graph) may include original features inputted from the client device as described above, and a feature graph of a k^{th} order (or k-order feature graph) may include interactive or combinatorial features of a k^{th} order and lower. In implementations, an interactive feature of a k^{th} order may include a crossing product of k distinct features, wherein k is an integer greater than or equal to one.

In implementations, the interactive feature generation system 102 may cross an interactive feature of a lower order with a feature in a feature graph of a first order to generate an interactive feature of a higher order through an edge search. In implementations, the edge search may include, but is not limited to, an edge search through a Markov Decision Process as described in the foregoing description. In implementations, the interactive feature generation system 102 may determine whether to connect two interactive features of the lower order to form an interactive feature of the higher order based at least in part on a reward function as described in the foregoing description. For example, the reward function may include an immediate reward portion related to usefulness of generating interactive features of a low order and a long-term reward portion related to usefulness of generating interactive features of a high order.

In implementations, the interactive feature generation system 102 may employ an edge state H=[H¹, H², . . . , H^{K}] to represent probabilities of interactions between nodes in the Feature Graph [symbol] , with K being the highest order of feature crossing or feature interaction as described in the foregoing description. The interactive feature generation system 102 may then determine adjacency matrices A via an edge search. By way of example and not limitation, the interactive feature generation system 102 may employ a Markov Decision Process (MDP) to model a process of determining adjacency matrices A via an edge search. For example, the interactive feature generation system 102 may divide a generation of a k-order interactive feature f^{k} into k consecutive decision steps. In each decision step, the interactive feature generation system 102 may select some of the first-order features (i.e., original features) that are received from the input data to cross with high-order interactive features to generate higher-order interactive features.

By way of example and not limitation, given a (k−1)-order interactive feature f^{k-1} as a current state, the interactive feature generation system 102 may make a strategic decision to select a certain first-order feature, and cross the selected first-order feature with the (k−1)-order interactive feature f^{k-1} to generate a k-order interactive feature f^{k}. In implementations, the edge state H, which represents a probability of an interaction between two nodes, may be used to guide a crossing decision of the interactive feature generation system 102. For example, a high probability of an interaction between two nodes (i.e., two features) means that a high probability of being selected for crossing between these two nodes (i.e., these two features). For further details of crossing an interactive feature of a lower order with a feature in a feature graph of a first order to generate an interactive feature of a higher order through an edge search, references can therefore be made to the foregoing description of the example interactive feature generation algorithm, and details thereof are not repeated herein.

At block 508, the interactive feature generation system 102 may propagate respective interactive features of the plurality of feature graphs of the different orders to a neural network to determine a number of interactive features of one or more orders, the determined number of interactive features of the one or more orders being used for training a predictive model to make inferences for the particular application.

In implementations, the interactive feature generation system 102 may propagate respective interactive features of the plurality of feature graphs of the different orders to a neural network to determine a number of interactive features of one or more orders. In implementations, the neural network may include, but is limited to, a graph-based neural architecture such as GNN (Graph Neural Network), etc. For example, given the Feature Graph [symbol] with node vectors N and corresponding adjacency matrices A obtained from the above operations, the interactive feature generation system 102 may aggregate, for each node, information from respective one-hop neighbors to form an aggregated node vector, which is a sum of initial node vectors (i.e., feature embedding vectors) of the neighbors in a k-order feature crossing. After K times of aggregation, the interactive feature generation system 102 may obtain node vectors nᵢ^{K}, which include k-order interactive or crossing features as described in the foregoing description. Since the node vectors nᵢ^{K} have interacted with respective K-order neighbors, the interactive feature generation system 102 may model K-order interactive or crossing features accordingly. For further details of propagating respective interactive features of the plurality of feature graphs of the different orders to a neural network to determine a number of interactive features of one or more orders, references can therefore be made to the foregoing description of the example interactive feature generation algorithm, and details thereof are not repeated herein.

At block 510, the interactive feature generation system 102 may collect data for the determined number of interactive features of the one or more orders, and train the predictive model using at least some of the collected data.

In implementations, after determining the number of interactive features used for training the predictive model, the interactive feature generation system 102 may collect data for the determined number of interactive features of the one or more orders, and train the predictive model using at least some of the collected data. For example, the interactive feature generation system 102 may employ some of the collected data as training data, and the rest of the collected data as testing data. In implementations, the interactive feature generation system 102 may collect the data for the determined number of interactive features from a database associated with the particular application. For example, if the particular application is a product recommendation application for a shopping website, the interactive feature generation system 102 may collect the data for the determined number of interactive features from a database associated with the shopping website, and the database may include data of customers that visit the website.

In implementations, the predictive model may include a lightweight model that is less complicated than the neural network. In implementations, the predictive model may include, but is not limited to, a linear regression model, a decision tree, a support vector machine, a simplified neural network, etc. In implementations, the interactive feature generation system 102 may perform conventional training and testing for predictive models such as a linear regression model, a decision tree, a support vector machine, etc., to train the predictive model using the collected data of the determined number of interactive features of the one or more orders.

For example, if the particular application is a product recommendation application and the predictive model is used for recommending products to a user, the plurality of distinct features may include a variety of distinct features, which may include, but are not limited to, a gender, an age, an income, a geographical location, an occupation, a number of past purchase, a total amount of past purchase, etc. Due to a large number of distinct features that may be available, in which some may be useful for making inferences or predictions while some may not, the interactive feature generation system 102 may select one or more orders of interactive features as determined above at block 508, and employ the one or more orders of interactive features to train one or more predictive models. Continuing the above example of the particular application as a product recommendation application, the determined number of interactive features of the one or more orders may include, for example, “gender⊗income⊗age”, “gender⊗geographical location”, “number of past purchase⊗total amount of past purchase⊗income⊗geographical location”, etc. The interactive feature generation system 102 may employ one or more of these interactive features of different orders to train a predictive model. Additionally or alternatively, the interactive feature generation system 102 may employ the determined number of interactive features of the one or more orders to train a plurality of predictive models, each predictive model being trained based on one or more interactive features of same or different orders, for example.

At block 512, the interactive feature generation system 102 may receive new data of the determined number of interactive features of the one or more orders, and make inferences for the particular application based on the received data using the predictive model.

In implementations, after obtaining the predictive model, the interactive feature generation system 102 may use the predictive model to make inferences for the particular application based on newly received data of the determined number of interactive features of the one or more orders.

Although the above method blocks are described to be executed in a particular order, in some implementations, some or all of the method blocks can be executed in other orders, or in parallel.

### CONCLUSION

Although implementations have been described in language specific to structural features and/or methodological acts, it is to be understood that the claims are not necessarily limited to the specific features or acts described. Rather, the specific features and acts are disclosed as exemplary forms of implementing the claimed subject matter. Additionally or alternatively, some or all of the operations may be implemented by one or more ASICS, FPGAs, or other hardware.

The present disclosure can be further understood using the following clauses.

Clause 1: A method implemented by one or more computing devices, the method comprising: associating a plurality of nodes in a feature graph of a first order with a plurality of distinct features that are associated with an application; iteratively generating interactive features of a higher order from interactive features of a lower order to form a plurality of feature graphs of different orders; and propagating respective interactive features of the plurality of feature graphs of the different orders to a neural network to determine a number of interactive features of one or more orders, the determined number of interactive features of the one or more orders being used for training a predictive model to make inferences for the application.

Clause 2: The method of Clause 1, wherein iteratively generating the interactive features of the higher order from the interactive features of the lower order to form the plurality of feature graphs of different orders comprises determining whether to connect two interactive features of the lower order to form an interactive feature of the higher order based at least in part on a reward function.

Clause 3: The method of Clause 1, wherein the reward function comprises an immediate reward portion related to usefulness of generating interactive features of a low order and a long-term reward portion related to usefulness of generating interactive features of a high order.

Clause 4: The method of Clause 1, further comprising receiving the plurality of distinct features in a tabular format.

Clause 5: The method of Clause 1, wherein associating the plurality of nodes in the feature graph of the first order with the plurality of distinct features that are associated with the inference application into comprises: converting the plurality of distinct features into a feature representation using an one-hot encoding; and mapping the feature representation into feature embedding vectors, the feature embedding vectors being treated as the plurality of nodes in the feature graph of the first order.

Clause 6: The method of Clause 1, wherein associating the plurality of nodes in the feature graph of the first order with the plurality of distinct features that are associated with the inference application into comprises: modeling each distinct features of the plurality of distinct features as a respective node of the plurality of nodes in the feature graph, and an interaction between two distinct features of the plurality of distinct features as an edge between corresponding nodes of the plurality of nodes in the feature graph.

Clause 7: The method of Clause 1, wherein iteratively generating the interactive features of the higher order from the interactive features of the lower order to form the plurality of feature graphs of the different orders comprises: crossing an interactive feature of the lower order with a feature in the feature graph of the first order to generate an interactive feature of the higher order through an edge search.

Clause 8: The method of Clause 7, wherein the edge search comprises an edge search through a Markov Decision Process.

Clause 9: The method of Clause 1, wherein an interactive feature of an order of k comprises a crossing product of k distinct features, wherein k is an integer greater than or equal to one.

Clause 10: The method of Clause 1, further comprising: collecting data for the determined number of interactive features of the one or more orders; and making new inferences for the application based on the collected data using the predictive model.

Clause 11: One or more computer readable media storing executable instructions that, when executed by one or more processors, cause the one or more processors to perform acts comprising: associating a plurality of nodes in a feature graph of a first order with a plurality of distinct features that are associated with an application; iteratively generating interactive features of a higher order from interactive features of a lower order to form a plurality of feature graphs of different orders; and propagating respective interactive features of the plurality of feature graphs of the different orders to a neural network to determine a number of interactive features of one or more orders, the determined number of interactive features of the one or more orders being used for training a predictive model to make inferences for the application.

Clause 12: The one or more computer readable media of Clause 11, wherein associating the plurality of nodes in the feature graph of the first order with the plurality of distinct features that are associated with the inference application into comprises: converting the plurality of distinct features into a feature representation using an one-hot encoding; and mapping the feature representation into feature embedding vectors, the feature embedding vectors being treated as the plurality of nodes in the feature graph of the first order.

Clause 13: The one or more computer readable media of Clause 11, wherein associating the plurality of nodes in the feature graph of the first order with the plurality of distinct features that are associated with the inference application into comprises: modeling each distinct features of the plurality of distinct features as a respective node of the plurality of nodes in the feature graph, and an interaction between two distinct features of the plurality of distinct features as an edge between corresponding nodes of the plurality of nodes in the feature graph.

Clause 14: The one or more computer readable media of Clause 11, wherein iteratively generating the interactive features of the higher order from the interactive features of the lower order to form the plurality of feature graphs of the different orders comprises: crossing an interactive feature of the lower order with a feature in the feature graph of the first order to generate an interactive feature of the higher order through an edge search.

Clause 15: The one or more computer readable media of Clause 11, wherein the acts further comprise: collecting data for the determined number of interactive features of the one or more orders; and making new inferences for the application based on the collected data using the predictive model.

Clause 16: A system comprising: one or more processors; and memory storing executable instructions that, when executed by the one or more processors, cause the one or more processors to perform acts comprising: associating a plurality of nodes in a feature graph of a first order with a plurality of distinct features that are associated with an application; iteratively generating interactive features of a higher order from interactive features of a lower order to form a plurality of feature graphs of different orders; and propagating respective interactive features of the plurality of feature graphs of the different orders to a neural network to determine a number of interactive features of one or more orders, the determined number of interactive features of the one or more orders being used for training a predictive model to make inferences for the application.

Clause 17: The system of Clause 16, wherein associating the plurality of nodes in the feature graph of the first order with the plurality of distinct features that are associated with the inference application into comprises: converting the plurality of distinct features into a feature representation using an one-hot encoding; and mapping the feature representation into feature embedding vectors, the feature embedding vectors being treated as the plurality of nodes in the feature graph of the first order.

Clause 18: The system of Clause 16, wherein associating the plurality of nodes in the feature graph of the first order with the plurality of distinct features that are associated with the inference application into comprises: modeling each distinct features of the plurality of distinct features as a respective node of the plurality of nodes in the feature graph, and an interaction between two distinct features of the plurality of distinct features as an edge between corresponding nodes of the plurality of nodes in the feature graph.

Clause 19: The system of Clause 16, wherein iteratively generating the interactive features of the higher order from the interactive features of the lower order to form the plurality of feature graphs of the different orders comprises: crossing an interactive feature of the lower order with a feature in the feature graph of the first order to generate an interactive feature of the higher order through an edge search.

Clause 20: The system of Clause 16, wherein the acts further comprise: collecting data for the determined number of interactive features of the one or more orders; and making new inferences for the application based on the collected data using the predictive model.

What is claimed is:

1. A method implemented by one or more computing devices, the method comprising:
associating a plurality of nodes in a feature graph of a first order with a plurality of distinct features that are associated with an application;
iteratively generating interactive features of a higher order from interactive features of a lower order to form a plurality of feature graphs of different orders; and
propagating respective interactive features of the plurality of feature graphs of the different orders to a neural network to determine a number of interactive features of one or more orders, the determined number of interactive features of the one or more orders being used for training a predictive model to make inferences for the application.

2. The method of claim 1, wherein iteratively generating the interactive features of the higher order from the interactive features of the lower order to form the plurality of feature graphs of different orders comprises determining whether to connect two interactive features of the lower order to form an interactive feature of the higher order based at least in part on a reward function.

3. The method of claim 2, wherein the reward function comprises an immediate reward portion related to usefulness of generating interactive features of a low order and a long-term reward portion related to usefulness of generating interactive features of a high order.

4. The method of claim 1, further comprising receiving the plurality of distinct features in a tabular format.

5. The method of claim 1, wherein associating the plurality of nodes in the feature graph of the first order with the plurality of distinct features that are associated with the inference application into comprises:
converting the plurality of distinct features into a feature representation using an one-hot encoding; and
mapping the feature representation into feature embedding vectors, the feature embedding vectors being treated as the plurality of nodes in the feature graph of the first order.

6. The method of claim 1, wherein associating the plurality of nodes in the feature graph of the first order with the plurality of distinct features that are associated with the inference application into comprises:
modeling each distinct features of the plurality of distinct features as a respective node of the plurality of nodes in the feature graph, and an interaction between two distinct features of the plurality of distinct features as an edge between corresponding nodes of the plurality of nodes in the feature graph.

7. The method of claim 1, wherein iteratively generating the interactive features of the higher order from the interactive features of the lower order to form the plurality of feature graphs of the different orders comprises:
crossing an interactive feature of the lower order with a feature in the feature graph of the first order to generate an interactive feature of the higher order through an edge search.

8. The method of claim 7, wherein the edge search comprises an edge search through a Markov Decision Process.

9. The method of claim 1, wherein an interactive feature of an order of k comprises a crossing product of k distinct features, wherein k is an integer greater than or equal to one.

10. The method of claim 1, further comprising:
collecting data for the determined number of interactive features of the one or more orders; and
making new inferences for the application based on the collected data using the predictive model.

11. One or more computer readable media storing executable instructions that, when executed by one or more processors, cause the one or more processors to perform acts comprising:
associating a plurality of nodes in a feature graph of a first order with a plurality of distinct features that are associated with an application;
iteratively generating interactive features of a higher order from interactive features of a lower order to form a plurality of feature graphs of different orders; and
propagating respective interactive features of the plurality of feature graphs of the different orders to a neural network to determine a number of interactive features of one or more orders, the determined number of interactive features of the one or more orders being used for training a predictive model to make inferences for the application.

12. The one or more computer readable media of claim 11, wherein associating the plurality of nodes in the feature graph of the first order with the plurality of distinct features that are associated with the inference application into comprises:
converting the plurality of distinct features into a feature representation using an one-hot encoding; and
mapping the feature representation into feature embedding vectors, the feature embedding vectors being treated as the plurality of nodes in the feature graph of the first order.

13. The one or more computer readable media of claim 11, wherein associating the plurality of nodes in the feature graph of the first order with the plurality of distinct features that are associated with the inference application into comprises:
modeling each distinct features of the plurality of distinct features as a respective node of the plurality of nodes in the feature graph, and an interaction between two distinct features of the plurality of distinct features as an edge between corresponding nodes of the plurality of nodes in the feature graph.

14. The one or more computer readable media of claim 11, wherein iteratively generating the interactive features of the higher order from the interactive features of the lower order to form the plurality of feature graphs of the different orders comprises:
crossing an interactive feature of the lower order with a feature in the feature graph of the first order to generate an interactive feature of the higher order through an edge search.

15. The one or more computer readable media of claim 11, wherein the acts further comprise:
collecting data for the determined number of interactive features of the one or more orders; and
making new inferences for the application based on the collected data using the predictive model.

16. A system comprising:
one or more processors;
memory storing executable instructions that, when executed by the one or more processors, cause the one or more processors to perform acts comprising:
associating a plurality of nodes in a feature graph of a first order with a plurality of distinct features that are associated with an application;
iteratively generating interactive features of a higher order from interactive features of a lower order to form a plurality of feature graphs of different orders; and
propagating respective interactive features of the plurality of feature graphs of the different orders to a neural network to determine a number of interactive features of one or more orders, the determined number of interactive features of the one or more orders being used for training a predictive model to make inferences for the application.

17. The system of claim 16, wherein associating the plurality of nodes in the feature graph of the first order with the plurality of distinct features that are associated with the inference application into comprises:
converting the plurality of distinct features into a feature representation using an one-hot encoding; and
mapping the feature representation into feature embedding vectors, the feature embedding vectors being treated as the plurality of nodes in the feature graph of the first order.

18. The system of claim 16, wherein associating the plurality of nodes in the feature graph of the first order with the plurality of distinct features that are associated with the inference application into comprises:
modeling each distinct features of the plurality of distinct features as a respective node of the plurality of nodes in the feature graph, and an interaction between two distinct features of the plurality of distinct features as an edge between corresponding nodes of the plurality of nodes in the feature graph.

19. The system of claim 16, wherein iteratively generating the interactive features of the higher order from the interactive features of the lower order to form the plurality of feature graphs of the different orders comprises:
crossing an interactive feature of the lower order with a feature in the feature graph of the first order to generate an interactive feature of the higher order through an edge search.

20. The system of claim 16, wherein the acts further comprise:
collecting data for the determined number of interactive features of the one or more orders; and
making new inferences for the application based on the collected data using the predictive model.
